(19) United States
(12) Patent Application Publication
(10) Pub. No.: US 2011/0277908 A1
(43) Pub. Date: Nov. 17, 2011

(54) APPARATUS AND METHOD FOR SEALING A VENTILATION CHANNEL OF A PIPE

(76) Inventors: Dave DOWNING, West Chester, OH (US); Roger Siferd, Findlay, OH (US); Nicholas Piazza, Bridgeport, OH (US); Stan Holowiecki, Trenton, OH (US); Howard Montgomery, Findlay, OH (US)

(21) Appl. No.: 13/009,046

(22) Filed: Jan. 19, 2011

Related U.S. Application Data
(63) Continuation-in-part of application No. 12/779,634, filed on May 13, 2010.

(51) Int. Cl. B29C 65/08; B29C 65/30

(52) U.S. Cl. 156/73.5; 156/275.1; 156/321

(57) ABSTRACT

A method of sealing a ventilation channel for a pipe is disclosed. The method may include inserting a sealing insert into a ventilation hole of the ventilation channel, applying a vibrational energy to a region between the sealing insert and the ventilation channel, deactivating the vibrational energy once the sealing insert and the ventilation channel are welded together at the region, and forming a flush interface between the sealing insert and the ventilation channel at the ventilation hole.

### CROSS-REFERENCE TO RELATED APPLICATION

This application is a continuation-in-part of U.S. application Ser. No. 12/779,634, filed May 13, 2010, which is incorporated herein by reference in its entirety.

### FIELD OF THE DISCLOSURE

The present disclosure is related to a corrugated pipe, and more particularly, to an apparatus and method for sealing a ventilation channel of a corrugated pipe.

### BACKGROUND OF THE DISCLOSURE

Generally speaking, drainage systems may employ corrugated pipes to collect and convey fluids and debris to desired locations in various agricultural, residential, recreational, or civil engineering and construction applications. Such corrugated pipes may typically be formed via extrusion processes, where, for example, a vacuum is often used to draw molten material into a mold to form corrugations. In one example, a corrugated pipe may be manufactured by co-extruding a smooth inner pipe wall and an outer pipe wall having a plurality of corrugations. As a result, hollow chambers may be formed between the inner pipe wall and each corrugation of the outer pipe wall.

As the corrugated pipe is released from the mold, the molten material begins to cool. Accordingly, hot air or gas contained within each chamber also cools, becoming more dense and ultimately creating a partial vacuum. In some instances, this partial vacuum formed in each sealed chamber may create undesirable deforming forces, causing, among other things, the molded corrugations to warp or collapse.

One contemplated remedy for such an undesirable vacuum includes, for example, puncturing one or more ventilation holes into each corrugation to allow ambient air to enter the chambers as the air or gas therein cools down. However, puncturing each corrugation may weaken the outer surface of the pipe, making the pipe susceptible to damage and failure from applied loads and pressures to the outer surface.

Alternatively, one or more ventilation channels may be formed between each corrugation and serially extend along the length of the corrugated pipe, terminating with openings at the terminal ends of the corrugated pipe. Accordingly, as hot air in each chamber cools down and undergoes the above-described vacuuming effect, ambient air is “sucked in” to each chamber through the vent channels, thereby preventing deformation and collapse of the corrugations.

Although such ventilation channels may be advantageous in corrugated pipe production, they do have certain limitations. One problem is associated with sealing the ventilation channels. In use, the ventilations channels must be sealed from the outside environment. This is necessary to prevent entry of fluid and debris into the chambers of the corrugations through the ventilation channels. Entry of contaminants, such as fluid and debris, into the chambers may undesirably damage or deform, for example, the inner pipe wall and/or the corrugation of the outer pipe wall.

Contemplated seals include, for example, adhesives and plastic welds. Such seals, however, may be deficient at least in terms of strength and consistency, and also may take an undesirably excessive amount of time to dry or cure.

Accordingly, the sealing insert of the present disclosure is directed to improvements in the existing technology.

### SUMMARY OF THE DISCLOSURE

One exemplary aspect of the present disclosure is directed to a method of sealing a ventilation channel for a pipe. The method may include inserting a sealing insert into a ventilation hole of the ventilation channel, applying a vibrational energy to a region between the sealing insert and the ventilation channel, deactivating the vibrational energy once the sealing insert and the ventilation channel are welded together at the region, and forming a flush interface between the sealing insert and the ventilation channel at the ventilation hole.

Another exemplary aspect of the present disclosure is directed to another method of sealing a ventilation channel for a pipe. The method may include inserting a sealing insert into a ventilation hole of the ventilation channel, applying heat to the sealing insert such that the sealing insert melts within the ventilation channel, and manipulating the melting sealing insert to cover the ventilation hole.

Yet another exemplary aspect of the present disclosure is directed to another method of sealing a ventilation channel for a pipe, the ventilation channel including a ventilation hole and a wall. The method may include applying heat to opposite sides of the wall, folding the opposite sides of the wall together to close the ventilation hole and seal the ventilation channel, and applying pressure to the folded channel wall.

In this respect, before explaining at least one embodiment of the present disclosure in detail, it is to be understood that the present disclosure is not limited in its application to the details of construction and to the arrangements of the components set forth in the following description or illustrated in the drawings. The present disclosure is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings illustrate certain exemplary embodiments of the present disclosure, and together with the description, serve to explain the principles of the present disclosure.

As such, those skilled in the art will appreciate that the conception upon which this disclosure is based may readily be used as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 is a partial view of a corrugated pipe according to an exemplary disclosed embodiment;

FIG. 2 is another view of the corrugated pipe of FIG. 1 according to an exemplary disclosed embodiment

FIG. 3 is a partial, cross-sectional view of the corrugated pipe of FIG. 1 taken along dashed line “A” of FIG. 2 according to an exemplary disclosed embodiment;

FIG. 4A is a view of a sealing insert for sealing a ventilation channel of a corrugated pipe according to an exemplary disclosed embodiment;

FIG. 4B is a view of a sealing insert for sealing a ventilation channel of a corrugated pipe according to an alternative exemplary disclosed embodiment;

FIG. 4C is a view of a sealing insert for sealing a ventilation channel of a corrugated pipe according to an alternative exemplary disclosed embodiment;

FIG. 4D is a view of a sealing insert for sealing a ventilation channel of a corrugated pipe according to an alternative exemplary disclosed embodiment;

FIG. 5 is a depiction of the sealing insert of FIG. 2A inserted within the ventilation channel of the corrugated pipe as shown in FIG. 3 according to an exemplary disclosed embodiment;

FIG. 6 is a depiction of the sealing insert of FIG. 2A sealed within the ventilation channel of the corrugated pipe as shown in FIG. 3 according to an exemplary disclosed embodiment;

FIG. 7 is a further depiction of the sealing insert of FIG. 2A sealed within the ventilation channel of the corrugated pipe as shown in FIG. 3 according to an exemplary disclosed embodiment;

FIG. 8 is a further depiction of the sealing insert of FIG. 2A sealed within the ventilation channel of the corrugated pipe as shown in FIG. 3 according to an exemplary disclosed embodiment;

FIG. 9 is a depiction of the sealing insert of FIG. 2B inserted within the ventilation channel of the corrugated pipe as shown in FIG. 3 according to an exemplary disclosed embodiment;

FIG. 10 is a depiction of the sealing insert of FIG. 2B sealed within the ventilation channel of the corrugated pipe as shown in FIG. 3 according to an exemplary disclosed embodiment;

FIG. 11 is a depiction of a sealing insert being sealed within the ventilation channel of the corrugated pipe as shown in FIG. 3 by a vibrational welding apparatus according to an exemplary disclosed embodiment;

FIG. 12 is a depiction of the sealing insert of FIG. 11 sealed within the ventilation channel of the corrugated pipe according to an exemplary disclosed embodiment;

FIG. 13 is a further depiction of the sealing insert of FIG. 11 sealed within the ventilation channel of the corrugated pipe according to an exemplary disclosed embodiment;

FIG. 14 is a view of a sealing insert coupled to an electrofusion welding apparatus for sealing a ventilation channel of a corrugated pipe according to an exemplary disclosed embodiment;

FIG. 15 is a depiction of the sealing insert and the electrofusion welding apparatus of FIG. 14 inserted within the ventilation channel of the corrugated pipe as shown in FIG. 3 according to an exemplary disclosed embodiment;

FIG. 16 is a depiction of the sealing insert and the electrofusion welding apparatus of FIG. 14 sealed within the ventilation channel of the corrugated pipe as shown in FIG. 3 according to an exemplary disclosed embodiment;

FIG. 17 is a further depiction of the sealing insert and a portion of the electrofusion welding apparatus of FIG. 14 sealed within the ventilation channel of the corrugated pipe as shown in FIG. 3 according to an exemplary disclosed embodiment;

FIG. 18 is a depiction of a heating element applied to the ventilation channel of the corrugated pipe as shown in FIG. 3 according to an exemplary disclosed embodiment;

FIG. 19 is a further depiction of the heating element of FIG. 18 applied to the ventilation channel of the corrugated pipe as shown in FIG. 3 according to an exemplary disclosed embodiment;

FIG. 20 is a depiction of the heating element of FIG. 18 applied to the sealing insert as shown in FIG. 4B according to an exemplary disclosed embodiment;

FIG. 21 is a depiction of the sealing insert as shown in FIG. 20 inserted into the ventilation channel as shown in FIG. 19 according to an exemplary disclosed embodiment;

FIG. 22 is a depiction of the heating element of FIG. 18 applied to the inserted sealing insert and ventilation channel as shown in FIG. 21 according to an exemplary disclosed embodiment;

FIG. 23 is a depiction of a force being applied to the inserted sealing insert and ventilation channel as shown in FIG. 22 according to an exemplary disclosed embodiment;

FIG. 24 is a further depiction of the inserted sealing insert and ventilation channel as shown in FIG. 23 according to an exemplary disclosed embodiment;

FIG. 25 is a depiction of a force being applied to the ventilation channel after the application of the heating element as shown in FIG. 19 according to an exemplary disclosed embodiment; and

FIG. 26 is a depiction of the ventilation channel of FIG. 25 being sealed according to an exemplary disclosed embodiment.

### DETAILED DESCRIPTION

Reference will now be made in detail to the exemplary embodiments of the present disclosure described above and illustrated in the accompanying drawings.

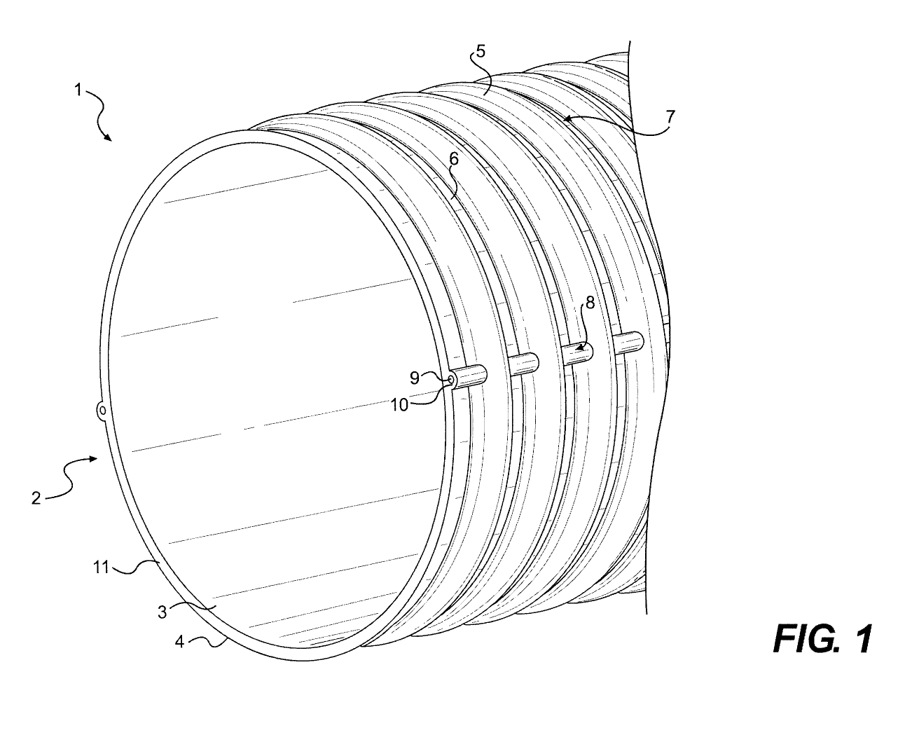

FIG. 1 illustrates a partial view of an exemplary corrugated pipe 1. Corrugated pipe 1 may be a dual-wall, corrugated pipe including an opening 2, an inner wall 3, and a corrugated outer wall 4. In one embodiment, inner wall 3 and corrugated outer wall 4 may be co-extruded using an extruder. Inner wall 3 and corrugated outer wall 4 then may be molded together by a corrugator. Alternatively, inner wall 3 may be separately fused to corrugated outer wall 4.

As illustrated in FIG. 1, inner wall 3 may be substantially smooth. Moreover, corrugated outer wall 4 may include a plurality of corrugation crests 5 and corrugation valleys 6. Corrugated outer wall 4 may also include a plurality of chambers 7, each defined by a respective primary corrugation crest 5 and inner wall 3.

In certain embodiments, corrugated pipe 1 may consist of this dual-wall, corrugated pipe (i.e., corrugated pipe 1 is defined by inner wall 3 and corrugated outer wall 4), as illustrated in FIG. 1. It should also be appreciated that this dual-wall corrugated pipe 1 may be passed through a downstream, cross-head die, which extrudes a second outer wall onto dual-wall pipe 1, thereby creating a three-wall corrugated pipe. Because the second outer wall would be extruded onto corrugated outer wall 4 while one or both of the second outer wall and corrugated outer wall 4 is still hot (i.e., in a melted or semi-melted state), the second outer wall may be fused or cohesively bonded to corrugation crests 5 of the corrugated outer wall 4.

Corrugated pipe 1 also may include one or more ventilations channels 8 integrally formed with corrugated outer wall 4 and inner wall 3. Ventilation channel 8 may be, for example, a hollow tubular member in fluid communication with each chamber 7 and may include a ventilation hole 9 having an outer periphery 10 defined by the radial surface of the hollow tubular member. Ventilation channel 8 may be disposed along the length of corrugated pipe 1 and may terminate with ventilation hole 9 at a terminal end 11 of corrugated pipe 1. Therefore, each chamber 7 may be in fluid communication with the ambient air surrounding corrugated pipe 1 via ventilation channel 8. And, as hot air contained in each chamber 7 due to the extrusion process cools down, becoming more dense, deformation of corrugated outer wall 4 may be prevented because of the ventilation between each chamber 7 and its surrounding environment.

In the exemplary embodiment illustrated in FIG. 1, ventilation channel 8 may be a single, continuous tubular member parallel with a longitudinal axis of corrugated pipe 1 and extending through each of the plurality of chambers 7. In another embodiment, ventilation channel 8 may include a plurality of distinct tubular members, each in communication with adjacent chambers 7 and arranged in a staggered configuration relative to each other around an outer circumference of corrugated outer wall 4. In other words, ventilation channel 8 may include a plurality of distinct tubular members not aligned with each other along the length of corrugated pipe 1.

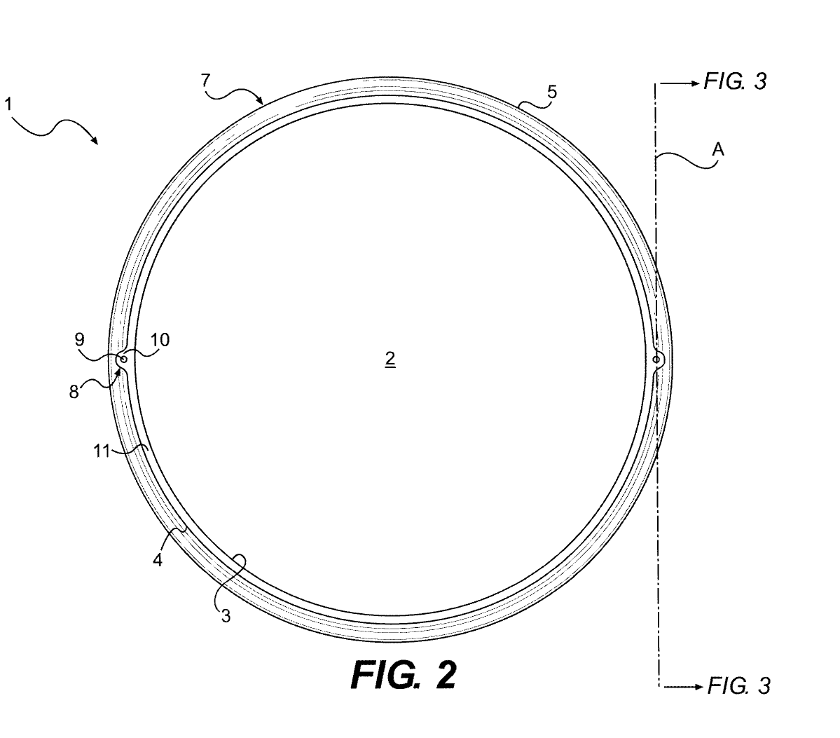

FIG. 2 illustrates a view of corrugated pipe 1, according to the exemplary embodiment illustrated in FIG. 1, from the perspective of terminal end 11 and into opening 2. As discussed above, each ventilation channel 8 may terminate at terminal end 11 with ventilation hole 9. Although two ventilation channels 8 are illustrated in FIG. 2, it should be appreciated that corrugation pipe 1 may include less or more than two ventilation channels 8. It also should be appreciated that in certain embodiments, a plurality of ventilation channels 8 may be disposed symmetrically around the outer circumference of corrugated outer wall 4, while in other embodiments, a plurality of ventilation channels 8 may be asymmetrically disposed around the outer circumference of corrugated outer wall 4.

FIG. 2 also illustrates that the width of ventilation channel 8 defined by inner wall 3 and corrugated outer wall 4 is less than the width of chambers 7 (i.e., the radial height of ventilation channel 8 is less than the radial height of corrugation crest 5). Such a configuration may provide a low profile for ventilation channel 8 to prevent accumulation of dirt, debris, and fluid on the corrugated outer wall 4 from a worksite. It also should be appreciated that the width of ventilation channel 8 may be substantially the same as the width of chambers 7, to provide a larger channel for improved ventilation.

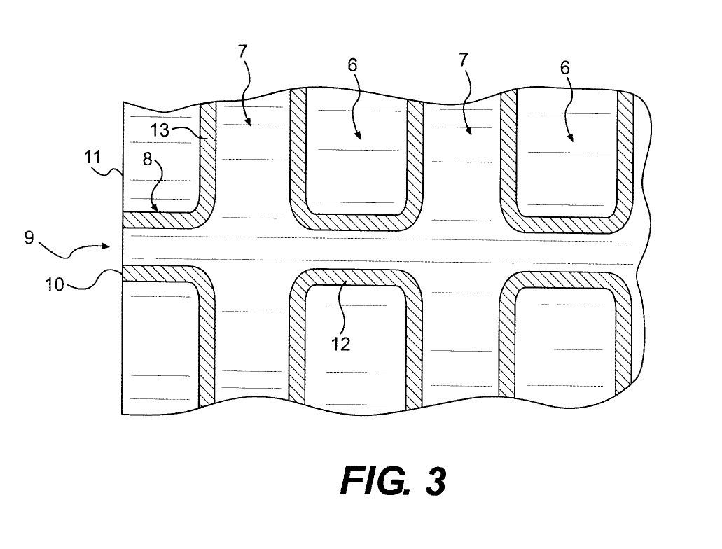

FIG. 3 illustrates a partial, cross-sectional depiction of corrugated pipe 1 along dashed line “A” of FIG. 2. As discussed above, ventilation channel 8 terminates at ventilation hole 9 at terminal end 11 of corrugated pipe 1. Terminal end 11 may be aligned with outer periphery 10 of ventilation hole 9. Ventilation channel 8 may be in fluid communication with each chamber 7 and may longitudinally extend between adjacent chambers 7, being positioned in valleys 6.

As depicted in FIG. 3, ventilation channel 8 may be integrally formed with each chamber 7. More particularly, a wall 12 of ventilation channel 8 may be integrally formed and contiguous with a wall 13 of chamber 7. It should also be appreciated that wall 12 of ventilation channel 8 may be formed of a different material than that of wall 13 of chamber 7 so as to vary the structural characteristics of each. For example, wall 13 of corrugation chamber 7 may be made of a more rigid, impact resistant plastic, while wall 12 of ventilation channel 8 may be made of a softer and more flexible plastic.

Although wall 12 of ventilation channel 8 and wall 13 of chamber 7 are illustrated as having substantially the same thickness, it should also be appreciated that wall 12 and wall 13 may have varying thickness to impart different structural rigidities and/or compliances between ventilation channel 8 and chamber 7.

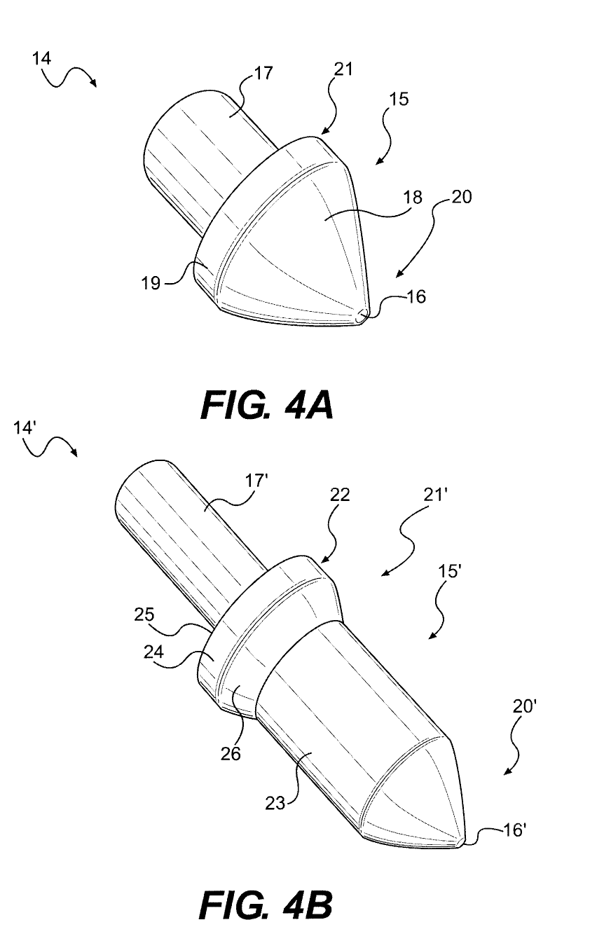

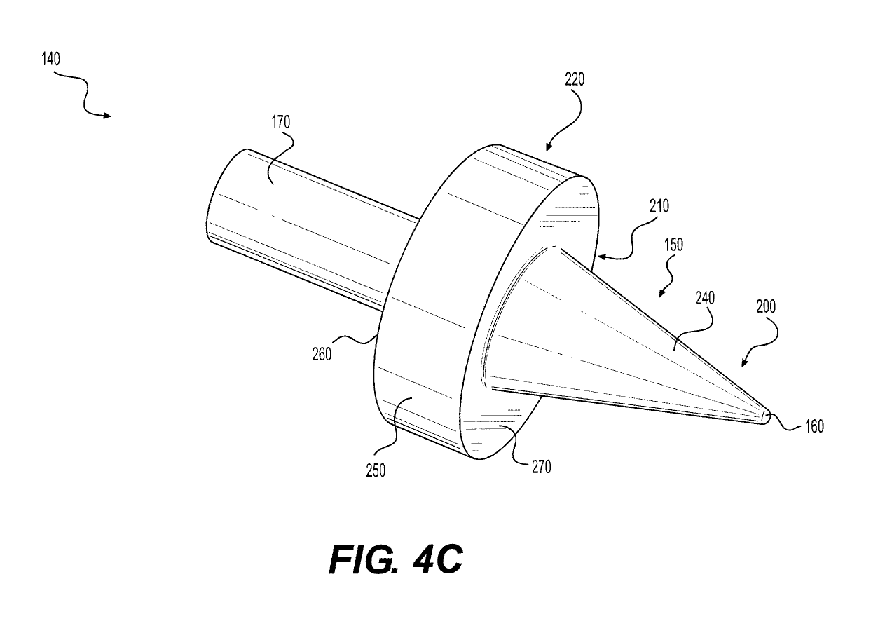

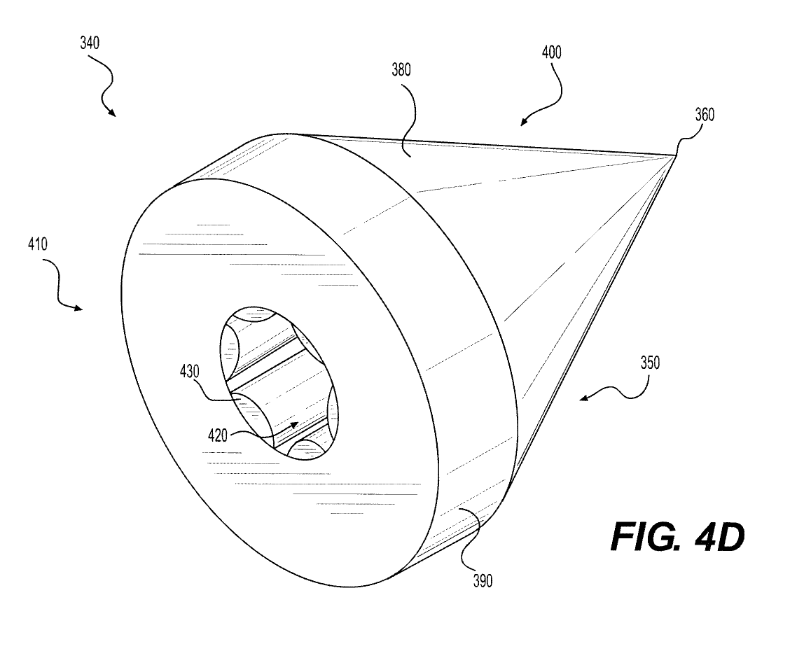

As will be discussed in more detail with respect to FIGS. 4A through 10, once corrugated pipe 1 has substantially cooled following the extrusion process, ventilation channel 8 may then be sealed with an appropriate sealing insert.

FIG. 4A illustrates an exemplary sealing insert 14 for sealing ventilation channel 8. Sealing insert 14 may include an insertion body 15 having a pointed tip 16 and a connecting member 17 coupled to insertion body 15. In one embodiment, sealing insert 14 may be injection molded or machined from a variety of plastic materials, such as polyethylene, polyvinyl chloride, polyester, polypropylene, polyamide, polyurethane, polystyrene, fluorine plastics, and the like. Sealing insert 14 may be a single piece of a material such that insertion body 15 and connecting member 17 may be continuously formed. Alternatively, insertion body 15 and connecting member 17 may be separate components formed from the same or different types of material. In such embodiments, connecting member 17 may be detachably engaged with insertion body 15 by a weld, adhesive, or the like.

Insertion body 15 may generally include a smooth, conical member 18 on a distal end 20 of insertion body 15, and transitioning to a smooth, cylindrical member 19 on a proximal end 21 of insertion body 15, as illustrated in FIG. 4A. Additionally, insertion body 15 may include a terminal width at proximal end 21 larger than the width of ventilation channel 8. It should also be appreciated that insertion body 15 may include ridges, cleats, spikes, nubs, or the like to enhance the engagement of sealing insert 14 into ventilation channel 8.

Pointed tip 16 may be defined on a distalmost end of insertion body 15 and may facilitate the entry of insertion body 15 into ventilation channel 8. Pointed tip 16 may include a sharp point, or alternatively, may include a flattened point.

Connecting member 17 may be configured to be coupled to a spinning mechanism (not shown), such as a mechanical power drill, air drill, or the like. In certain embodiments, connecting member 17 may be coupled to the spinning mechanism in a manner similar to a drill bit engaged with a power drill. As illustrated in FIG. 4A, connecting member 17 may be a smooth, cylindrical member having a width smaller than the terminal width of insertion body 15. In other embodiments, connecting member 17 may include a polygonal shape such that the outer surface of connecting member 17 may improve the connection of sealing insert 14 with the spinning mechanism.

FIG. 4B illustrates an exemplary embodiment of another sealing insert 14′. Sealing insert 14′ may include an insertion body 15′ having a pointed tip 16′, a capping portion 22, and a connecting member 17′ coupled to capping portion 22. In a similar manner as described above with regards to the embodiment of FIG. 4A, sealing insert 14′ may be injection molded or machined from a variety of plastic materials to form a single piece of continuous material. In certain other embodiments, connecting member 17′ may be a separate component from insertion body 15′ and capping portion 22 and may be formed of the same or a different type of material. In such embodiments, connecting member 17′ may be detachably engaged with capping portion 22 by a weld, adhesive, or the like.

As illustrated in the embodiment of FIG. 4B, insertion body 15′ may include a cylindrical body 23. Cylindrical body 23 may include an appropriate width larger than the width of ventilation channel 8. Although illustrated in FIG. 4B as having a substantially smooth outer surface, cylindrical body 23 may, in certain embodiments, include ridges, cleats, spikes, nubs, or the like, as described above with reference to the embodiment of FIG. 4A. Cylindrical body 23 may transition to pointed tip 16′ at a distal end 20′ of sealing insert 14′ and may be integrally formed with capping portion 22 at a proximal end 21′ of cylindrical body 23. Pointed tip 16′ also may facilitate the entry of insertion body 15′ into ventilation channel 8 and may include a sharp point, or alternatively, a flattened point.

Capping portion 22 may include a substantially disk-shaped member 24 having a flat surface 25 engaged with connecting member 17′ and a tapered surface 26 integrally formed with cylindrical body 23. Substantially disk-shaped member 24 may include a diameter larger than the width of cylindrical body 23. Moreover, the diameter of disk-shaped member 24 may be appropriately sized to “cap” ventilation hole 9 and cover outer periphery 10 of ventilation hole 9. Accordingly, sealing insert 14′ may provide a surface for sealing ventilation channel 8, external to ventilation channel 8, via capping portion 22, in addition to the sealing surface within ventilation channel 8 provided by insertion body 15′.

In addition, tapered surface 26 of sealing insert 14′ may provide a tighter interface between sealing insert 14′ and ventilation channel 8 at ventilation hole 9. That is, the angled configuration of tapered surface 26 may wedge against wall 12 of ventilation channel 8 at ventilation hole 9.

Similar to the embodiment of FIG. 4A, connecting member 17′ also may be coupled to an appropriate spinning mechanism. Likewise, connecting member 17′ also may be a smooth, cylindrical member, or in certain embodiments, include a polygonal shape.

FIG. 4C illustrates an exemplary embodiment of yet another sealing insert 140. Sealing insert 140 may include an insertion body 150 having a pointed tip 160, a capping portion 220, and a connecting member 170 coupled to capping portion 220. In some embodiments, sealing insert 140 may be injection molded or machined from a variety of plastic materials to form a single piece of a continuous material. In certain other embodiments, connecting member 170 may be a separate component from insertion body 150 and capping portion 220, wherein connecting member 170 may be detachably engaged with capping portion 220 via a weld, adhesive, or the like. Connecting member 170 also may be coupled to an appropriate spinning mechanism.

Insertion body 150 may include a conical member 240. Conical member 240 may include a width larger than the width of ventilation channel 8. For example, the portion of conical member 240 terminating at capping portion 220 may be wider than the width of ventilation channel 8. Further, conical member 240 may transition to pointed tip 160 at a distal end 200 of sealing insert 140 and may be integrally formed with capping portion 220 at a proximal end 210 of conical member 240.

Capping portion 220 may include a cylindrical member 250 having a first substantially flat surface 260 engaged with connecting member 170 and a second substantially flat surface 270 integrally formed with conical member 240. Cylindrical member 250 may include a diameter larger than the width of conical member 240. Further, the diameter of cylindrical member 250 may be appropriately sized to “cap” ventilation hole 9 and cover outer periphery 10 of ventilation hole 9. In particular, second substantially flat surface 270 may abut against outer periphery 10 and form a substantially flat connection interface. Accordingly, sealing insert 140 may provide a surface for sealing ventilation channel 8, external to ventilation channel 8, via capping portion 220, in addition to the sealing surface within ventilation channel 8 provided by insertion body 150.

FIG. 4D illustrates an exemplary embodiment of another sealing insert 340. Sealing insert 340 may include an insertion body 350 having a pointed tip 360. Sealing insert 340 may be injection molded or machined from a variety of plastic materials.

Insertion body 350 may generally include a conical member 380 on a distal end 400 of insertion body 350, and transitioning to a smooth, cylindrical member 390 on a proximal end 410 of insertion body 350, as illustrated in FIG. 4D. Additionally, insertion body 350 may include a terminal width at proximal end 410 larger than the width of ventilation channel 8. Pointed tip 360 may be defined on a distalmost end of insertion body 350 and may facilitate the entry of insertion body 350 into ventilation channel 8. Pointed tip 360 may include a sharp point, or alternatively, may include a flattened point.

Insertion body 350 may also include a connection port 420 at proximal end 410 of insertion body 350. Connection port 420 may be configured to facilitate the connection of a bit, rod, or the like associated with a spinning mechanism. In such an embodiment, the bit or rod of the spinning mechanism, serving as a connecting member to sealing insert 340, may be readily detached from insertion body 350. That is, once insertion body 350 has been sealed into ventilation channel 8, the bit or rod of the spinning mechanism may be removed from connection port 420. As illustrated in FIG. 4D, connection port 420 may include a plurality of ridges 430 configured to strengthen the grip and connection of insertion body 420 to the bit or rod of the connecting member.

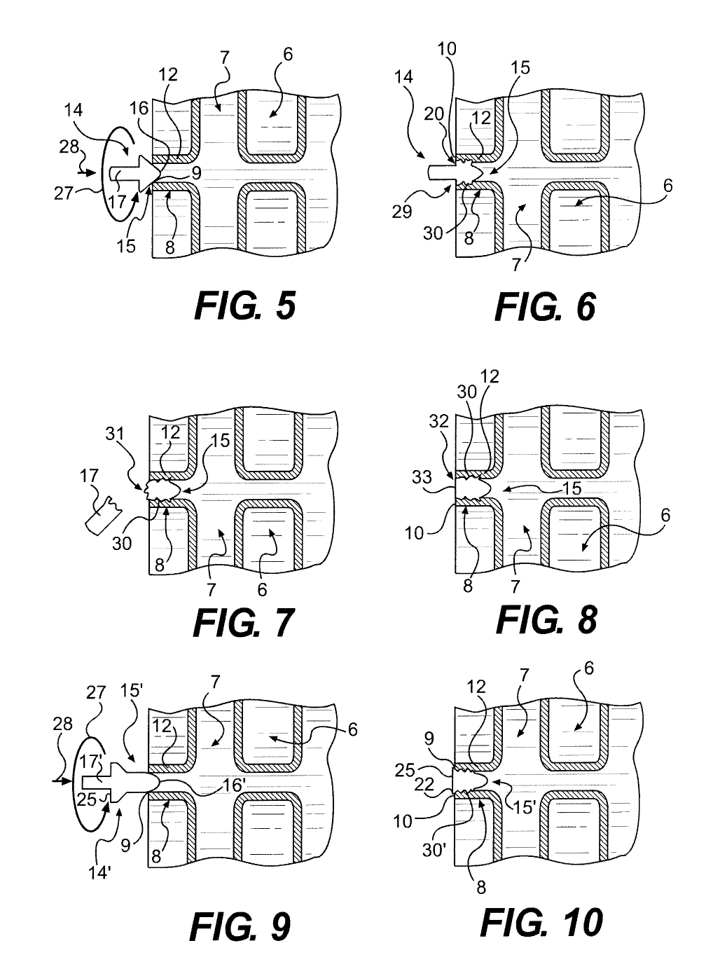

FIGS. 5-8 depict an exemplary method of sealing ventilation channel 8 of corrugated pipe 1 with sealing insert 14 in the perspective of an exemplary cross-section of corrugated pipe 1 illustrated in FIG. 3. Additionally, FIGS. 9-10 illustrate the application of sealing insert 14′ for sealing ventilation channel 8 in a substantially similar manner as will be described below with regards to FIGS. 5-8.

Sealing insert 14 first may be coupled to the appropriate spinning mechanism. Then, and as depicted in the exemplary embodiment of FIG. 5, pointed tip 16 of sealing insert 14 may be inserted into ventilation channel 8 through ventilation hole 9. Slight forward pressure may be applied to sealing insert 14 to set and position at least a portion of insertion body 15 within ventilation channel 8. In some embodiments, ventilation hole 9 may be widened by removing excess extruded material via drilling, cutting, or any other appropriate means prior to inserting sealing insert 14 into ventilation channel 8. Such a step may provide an appropriately sized ventilation hole 9 and fit for sealing insert 14.

As illustrated in FIG. 5, once at least a portion of insertion body 15 is disposed within ventilation channel 8, the spinning mechanism may then be activated. Activation of the spinning mechanism may translate clockwise, or alternatively counter-clockwise, rotational energy 27 to sealing insert 14 causing insertion body 15 to rotate against wall 12 of ventilation channel 8. Heat created by the rotational friction between insertion body 15 and wall 12 of ventilation channel 8 may begin to slightly melt and mold together the materials of insertion body 15 and wall 12. In addition to the rotational energy applied to sealing insert 14, axial force 28 also may be applied thereto (i.e., sealing insert 14 may be pushed forward) to facilitate the advancement of insertion body 15 into ventilation channel 8.

FIG. 6 illustrates an exemplary cross-sectional embodiment of sealing insert 14 welded into ventilation channel 8. Once sealing insert 14 reaches a predetermined, threshold position 29, for example, when distal end 20 of insertion body 15 sits flush with outer periphery 10 of ventilation hole 9, the spinning mechanism may be deactivated. Sealing insert 14 and the spinning mechanism may then be held in place for an appropriate amount of time to allow the melted materials of insertion body 15 and wall 12 of ventilation channel 8 to cool and weld together. The cooled materials accordingly may form a fluid-tight weld interface 30 between insertion body 15 and wall 12 of ventilation channel 8. Therefore, sealing insert 14 may seal ventilation channel 8 from the surrounding environment of corrugated pipe 1. After sufficient time has elapsed for insertion body 15 to weld into ventilation channel 8, sealing insert 14 may be inspected to test the adequacy of the weld. For example, sealing insert 14 may be pushed, pulled, twisted, or examined via any other appropriate range of motion to ensure that sealing insert 14 is securely welded within ventilation channel 8. If, for example, sealing insert 14 is loose, sealing insert 14 may be removed and a replacement sealing insert having, for example, a larger terminal width, may be spin welded into ventilation channel 8.

It should also be appreciated that ventilation channel 8 may be sealed by a friction fit between sealing insert 14 and wall 12 of ventilation channel 8. In such embodiments, sealing insert 14 may be gradually advanced into ventilation channel 8 by a sustained and low axial force or a sustained and low rotational force. The friction fit between sealing insert 14 and ventilation channel 8 may allow for removal of sealing insert 14, if necessary.

FIG. 7 illustrates an exemplary cross-sectional embodiment of sealing insert 14 welded within ventilation channel 8 and having connecting member 17 detached from insertion body 15. If it has been determined that sealing insert 14 is adequately secured within ventilation channel 8, connecting member 17 may be sheared off insertion body 15. In one embodiment, the deactivated spinning mechanism may be rotated clockwise such that connecting member 17 detaches from insertion body 15, with connecting member 17 remaining coupled to the spinning mechanism. In other embodiments, the spinning mechanism may be decoupled from connecting member 17, and connecting member 17 then may be cut or cleaved off insertion body 15 by any known means.

As discussed above, in certain embodiments, connecting member 17 may be detachably secured to insertion body 15 by certain known adhesive means. Additionally, connecting member 17 may include perforations or the like along the interface between connecting member 17 and insertion body 15 to facilitate detachment therebetween. In such embodiments, separation of connecting member 17 and insertion body 15 may leave a relatively smooth surface on insertion body 15 where connecting member 17 originally was engaged. Moreover, the aforementioned detachable arrangement between insertion body 15 and connecting member 17 may provide a quick and less difficult disassembly of insertion body 15 from the spinning mechanism, as connecting member 17 may be readily detached from insertion body 15.

In embodiments where sealing insert 14 may be formed from a single piece of continuous material, as illustrated in FIGS. 5-7, sealing insert 14 may have improved connection strength between insertion body 15 and connecting member 17. However, and as illustrated in FIG. 7, shearing connection member 17 from insertion body 15 may leave behind rough surface 31, for example, on insertion body 15. In some embodiments, it may then be desirable to remove rough surface 31, as illustrated in FIG. 8.

FIG. 8 illustrates an exemplary, cross-sectional embodiment of sealing insert 14 having a flush interface 32 with terminal end 11 of corrugated pipe 1. The aforementioned rough surface 31 may be deburred, sanded, abraded, or the like, to form flush interface 32. Flush interface 32 may be a smoothed surface 33 substantially aligned with outer periphery 10 of ventilation hole 9. Flush interface 32 therefore may provide unobstructed connections between multiple corrugation pipes 1 at their terminal ends 11.

FIG. 9 illustrates an exemplary, cross-sectional embodiment of sealing ventilation channel 8 of corrugated pipe 1 with sealing insert 14′. In a similar manner as discussed about with regards to FIGS. 5-8, sealing insert 14′ may be spin welded to wall 12 of ventilation channel 8.

Furthermore, and as illustrated in FIG. 10, insertion body 15′ may similarly form a fluid-tight weld interface 30′ with wall 12 of ventilation channel 8, as in the embodiments of FIGS. 6-8. Moreover, connecting member 17′ may be detached from capping portion 22, and any rough or unsmooth surfaces remaining on capping portion 22 due to the removal of connecting member 17′ may be treated to make smooth flat surface 25, in a similar manner as discussed above with regards to FIGS. 7-8.

As shown in FIG. 10, capping portion 22 may “cap” ventilation hole 9 by extending radially along outer periphery 10 of ventilation hole 9. Thus, the engagement of capping portion 22 to outer periphery 10 may provide additional surface area for sealing ventilation channel 8 and may serve to barricade external ventilation hole 9.

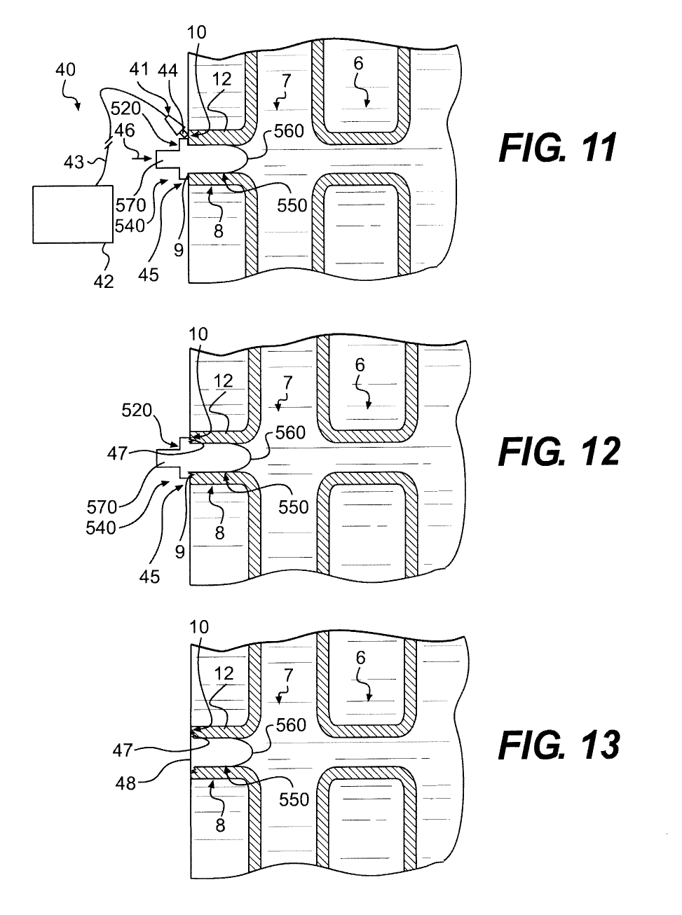

FIGS. 11-13 depict another exemplary method of sealing ventilation channel 8 of corrugated pipe 1 with a sealing insert 540 and a vibrational welding apparatus 40 in the perspective of an exemplary cross-section of corrugated pipe 1 illustrated in FIG. 3.

Sealing insert 540 may be injection molded or machined from a variety of thermoplastic materials, such as polyethylene, polyvinyl chloride, polyurethane, and the like. Sealing insert 540 may also include an insertion body 550, a capping portion 520, a tip 560, and a connecting member 570.

Sealing insert 540 may first be positioned within ventilation channel 8. More particularly, tip 560 may be inserted through ventilation hole 9 until insertion body 550 is disposed within ventilation channel 8 and capping portion 520 contacts outer periphery 10 of ventilation hole 9. In one embodiment, insertion body 550 may be slightly larger than an internal diameter of ventilation channel 8. Such a configuration may allow sealing insert 540 to remain secured within the ventilation channel 8 via, for example, a press or friction fit.

Vibrational welding apparatus 40 may include, for example, a sonotrode 41 connected to a transducer 42 via an electrical connection means 43, as is commonly known in the art. Sonotrode 41 may deliver acoustic or ultrasonic vibrational energy at a variety of vibrational frequencies. For example, sonotrode 41 may deliver vibrational energy between 15-100 kHz. Additionally, sonotrode 41 may be a handheld tool readily and easily manipulated by a user and may be sized and shaped such that a tip or operative end 44 of sonotrode 41 is in direct contact with both outer periphery 10 and sealing insert 540. Transducer 42 may be configured to receive electrical energy and deliver the electrical energy to sonotrode 41. Sonotrode 41 then may convert the electrical energy to mechanical vibrational energy at ultrasonic frequencies. A user may control the magnitude of electrical energy delivered to sonotrode 41 from transducer 42, and therefore, the degree of vibrational energy delivered from sonotrode 41. For example, transducer 42 may include a variety of knobs, switches, or the like actuated by a user to increase and decrease ultrasonic frequencies outputted by sonotrode 41.

Referring to the exemplary embodiment of FIG. 11, once sealing insert 540 is positioned within ventilation channel 8 as described above, sonotrode 41 may contact a region 45 between sealing insert 540 and ventilation channel 8 and apply vibrational energy to region 45. In one exemplary embodiment, region 45 may include the contact interface between capping portion 520 and outer periphery 10. The vibrational energy delivered from sonotrode 41 may create friction between sealing insert 540, particularly capping portion 520, and the surface of outer periphery 10, thereby melting and welding sealing insert 540 to ventilation channel 8. In one embodiment, sonotrode 41 may deliver vibrational energy around the entire contact interface between the capping portion 520 and outer periphery 10 to maximize the welding area between the sealing insert 540 and ventilation channel 8. Moreover, while sonotrode 41 is delivering vibrational energy, an axial force 46 may be applied to sealing insert 540 by, for example, a user holding connecting member 570 and applying forward pressure to sealing insert 540.

As illustrated in FIG. 12, sonotrode 41 may be deactivated and removed from sealing insert 540 and ventilation channel 8 once a weld 47 has formed between the contact interface between capping portion 520 and outer periphery 10. It should be appreciated that weld 47 may form a fluid-tight sealing interface between ventilation channel 8 and sealing insert 540, thereby sealing ventilation channel 8 from the surrounding environment of corrugated pipe 1.

FIG. 13 illustrates an exemplary cross-sectional embodiment of sealing insert 540 ultrasonically welded within ventilation channel 8 and having connecting member 570 detached from insertion body 550. Once it has been determined that sealing insert 540 is adequately secured with ventilation channel 8, connecting member 570 may be sheared, cut, or severed by any appropriate means. Furthermore, and in a similar manner as discussed with respect to FIG. 8, any rough or unsmooth surfaces remaining on capping portion 520 due to the removal of connecting member 570 may be treated to form a smooth flat surface 48.

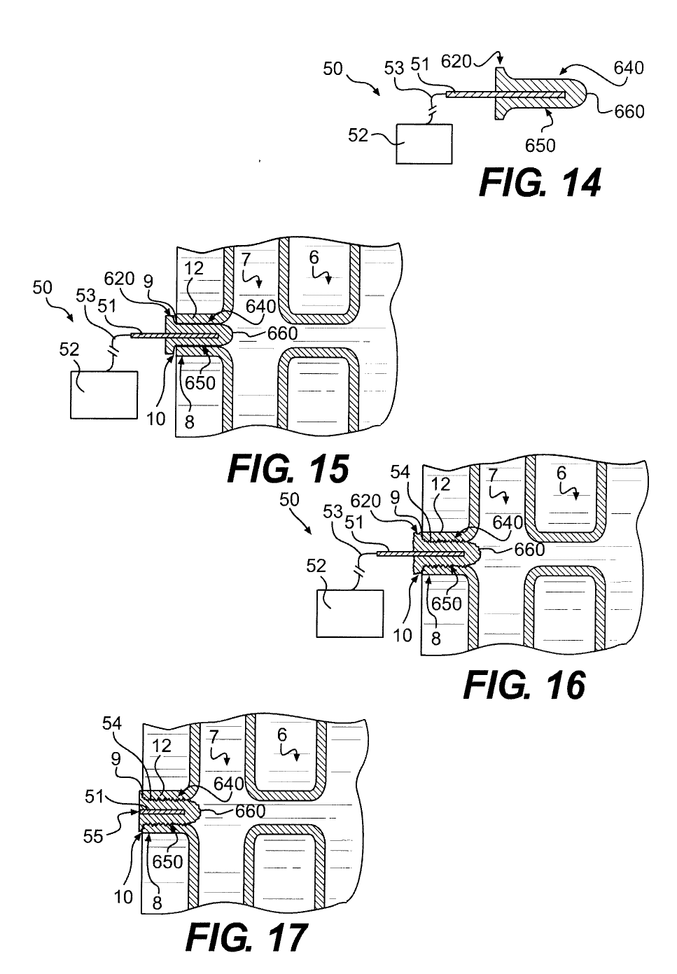

FIGS. 14-17 depict another exemplary method of sealing ventilation channel 8 of corrugated pipe 1 with a sealing insert 640 and an electrofusion welding apparatus 50 in the perspective of an exemplary cross-section of corrugated pipe 1 illustrated in FIG. 3.

As illustrated in FIG. 14, electrofusion welding apparatus 50 may include an electrically conductive member 51 coupled to an electrical source 52 via an electrical connection 53. Electrically conductive member 51 may include, for example, an electrically conductive plastic or metal rod, such as a copper wire. Electrical source 52 may be any suitable power source for delivering an appropriate electrical energy to electrically conductive member 51. For example, electrical source 52 may be an electrical control box configured to deliver a range of voltages and electrical currents to electrically conductive member 51. Electrical connection 53 may be any suitable electrical coupling member for transmitting electrical energy, such as, for example, an electrical lead.

Sealing insert 640 may also include an insertion body 650, a capping portion 620, and a tip 660. Additionally, and as depicted in FIG. 14, sealing insert 640 may be coupled to electrofusion welding apparatus 50. In one exemplary embodiment, sealing insert 640 may be injection molded or cast from a variety of thermoplastic materials directly onto electrically conductive member 51. In other embodiments, electrically conductive member 51 may be friction fit into a lumen defined within insertion body 650 of sealing insert 640.

As illustrated in FIG. 15, sealing insert 640 may first be positioned within ventilation channel 8. More particularly, tip 660 may be inserted through ventilation hole 9 until insertion body 650 is disposed within ventilation channel 8 and capping portion 620 contacts outer periphery 10 of ventilation hole 9. In one exemplary embodiment, sealing insert 640 may be secured within the ventilation channel 8 via, for example, a press or friction fit. In other embodiments, sealing insert 640 may be secured within the ventilation channel 8 via an appropriate adhesive between insertion body 650 and wall 12 of ventilation channel 8 prior to being welded to ventilation channel 8.

Once sealing insert 640 is adequately secured within ventilation channel 8, electrofusion welding apparatus 50 may be activated to weld sealing insert 640 onto ventilation channel 8. As illustrated in FIG. 16, activating electrofusion welding apparatus 50 includes delivering an electrical energy (e.g., an electrical current) from electrical source 52 to electrically conductive member 51. The electrical energy from electrically conductive member 51 may then heat sealing insert 640, and consequently, melt sealing insert 640 within ventilation channel 8. The heat radiating from electrically conductive member 51, and consequently sealing insert 640, may also melt at least a portion of wall 12. Once sealing insert 640 and portions of wall 12 have sufficiently melted and melded together, electrofusion welding apparatus 50 may be deactivated. The melded portions of sealing insert 640 and ventilation channel 8 may then form a fluid-tight sealing interface 54. In addition, capping portion 620 and the surface of outer periphery 10 may melt and meld together as a result of the electrical energy radiating from electrically conductive member 51.

As depicted in FIG. 17, once it has been determined that sealing insert 640 is adequately secured within ventilation channel 8, a portion of electrically conductive member 51 protruding from sealing insert 640 may be sheared or cleaved off. For example, the portion of electrically conductive member 51 extending from capping portion 620 and not surrounded by sealing insert 640 may be decoupled from sealing insert 640. In other embodiments, electrically conductive member 51 may be detachably connected to sealing insert 640 and may be readily disconnected from sealing insert 640 via perforations, removable adhesives, and the like. Furthermore, and in a similar manner as discussed in FIG. 8, any rough or unsmooth surfaces remaining on capping portion 620 and electrically conductive member 51 may be treated to form a smooth flat surface 55.

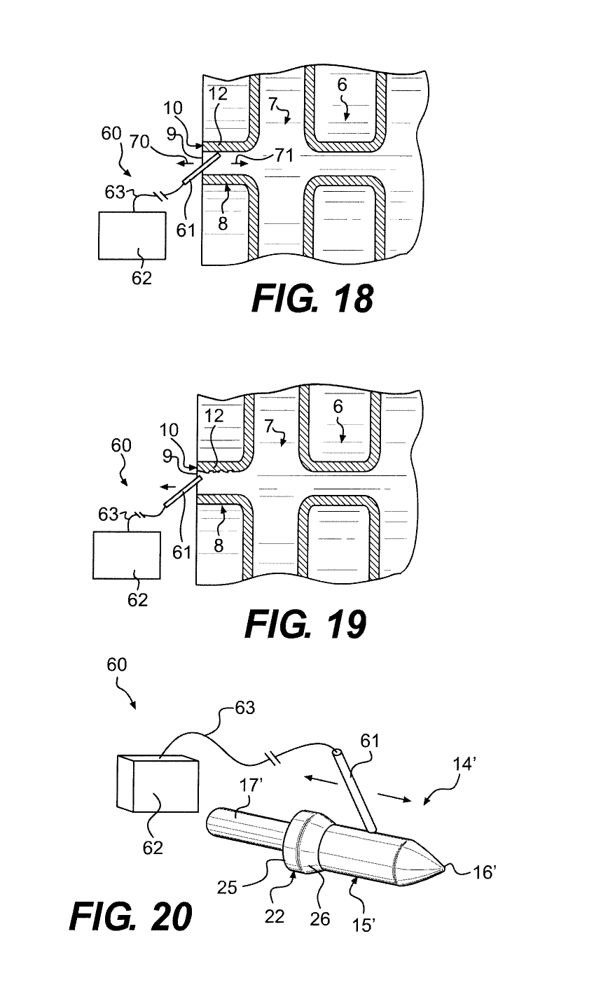

FIGS. 18-24 depict another exemplary method of sealing ventilation channel 8 of corrugated pipe 1 with sealing insert 14′ and a heating element 60 in the perspective of an exemplary cross-section of corrugated pipe 1 illustrated in FIG. 3.

In similar respects as electrofusion welding apparatus 50 of FIG. 14, heating element 60 may include an electrically conductive member 61 coupled to an electrical source 62 via an electrical connection 63. Electrically conductive member 61 may additionally include an electrically conductive plastic or metal rod coated with a non-stick material, such as, for example, polytetrafluoroethylene.

Heating element 60 may be activated such that electrical current is delivered to electrically conductive member 61, heating electrically conductive member 61 to a desired temperature. It should be appreciated that a user may control the temperature of electrically conductive member 61 by adjusting the amount of electrical energy delivered to electrically conductive member 61 from electrical source 62. As illustrated in FIG. 18, a user may then contact wall 12 of ventilation channel 8 with electrically conductive member 61, thereby melting a portion of wall 12. Electrically conductive member 61 may be translated back and forth within ventilation channel 8 in opposite directions 70, 71 to maximize the melting of the surfaces of wall 12.

FIG. 19 illustrates one side of wall 12 melted by electrically conductive member 61. Electrically conductive member 61 may then be removed from ventilation channel 8 and repositioned to melt the remaining sides of wall 12. Although FIGS. 18-19 depict electrically conductive member 61 scaled down relative to ventilation channel 8 for illustration purposes, it should also be appreciated that electrically conductive member 61 may also be sized to include a diameter slightly smaller than the diameter of ventilation channel 8. Such sizing may increase the contact area between electrically conductive member 61 and wall 12, allowing electrically conductive member 61 to be inserted into ventilation channel 8 to melt wall 12 with minimized motion and in a decreased amount of time.

As illustrated in FIG. 20, electrically conductive member 61 may then be employed to melt portions of sealing insert 14′. Although FIG. 20 illustrates the use of sealing insert 14′, it should also be appreciated that any other disclosed sealing insert may be employed. Electrically conductive member 61 may contact sealing insert 14′ and be translated along the length of sealing insert 14′ to melt surfaces of sealing insert 14′, such as pointed tip 16′, body portion 15′, and tapered surface 26 of capping portion 22.

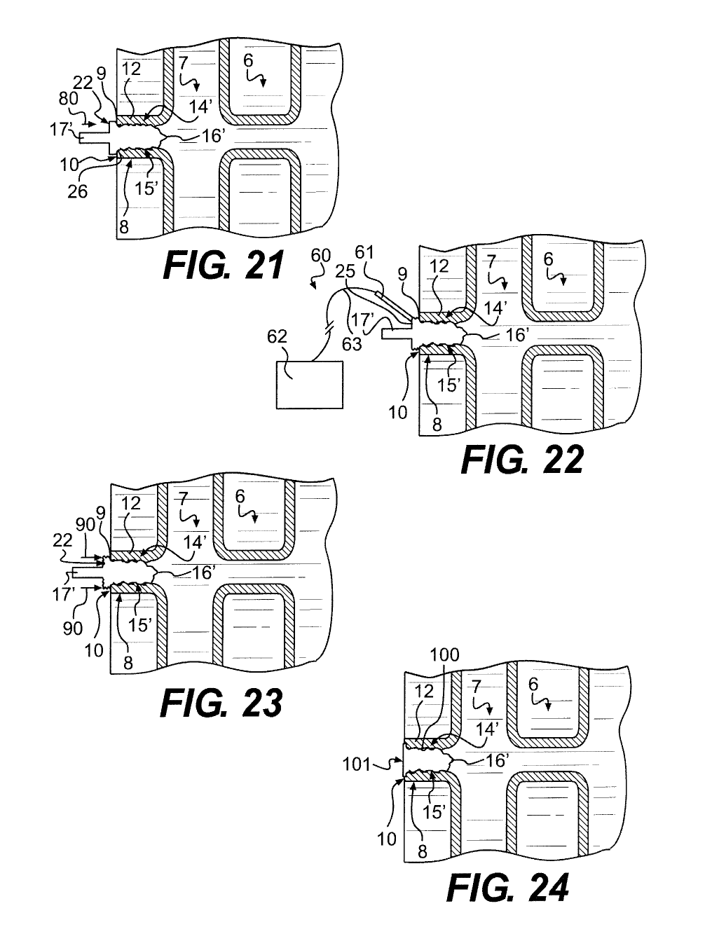

Once the selected surfaces of sealing insert 14′ have been melted, sealing insert 14′ may then be inserted into ventilation channel 8 to meld with the melted portions of wall 12. As illustrated in FIG. 21, sealing insert 14′ may be pushed forward in a direction 80 to facilitate the advancement of melted insertion body 15′ and pointed tip 16′ into ventilation channel 8.

Sealing insert 14′ may be advanced within ventilation channel 8 until at least a portion of melted tapered surface 26 is introduced into ventilation channel 8. Also, at this stage an additional portion of melted tapered surface 26 may contact outer periphery 10 of ventilation hole 9. As shown in FIG. 22, electrically conductive member 61 may then be utilized to melt the material of flat surface 25 and any other exposed portions of capping portion 22 external ventilation channel 8. Electrically conductive member 61 may also contact and melt the surface of outer periphery 10 proximate capping portion 22.

As illustrated in FIG. 23, melted capping portion 22 may be manipulated to further increase the surface area of capping portion 22 covering ventilation hole 9 and to enhance the melding of the melted surfaces of capping portion 22 and outer periphery 10. For example, in one embodiment, forward pressure 90 may be applied to the melted surfaces of capping portion 22 to press against outer periphery 10. Radial pressure may also be applied on the melted surfaces of capping portion 22 against outer periphery 10 to increase the melded surface area between the sealing insert 14′ and ventilation channel 8.

Melded sealing insert 14′ and ventilation channel 8 may then be allowed to cool and fasten together. The melded portions of sealing insert 14′ and ventilation channel 8 may form a fluid-tight sealing interface 100. As depicted in FIG. 24, once it has been determined that sealing insert 14′ is adequately secured and fastened with ventilation channel 8, connecting member 17′ may be sheared, cut, or severed by any appropriate means. Furthermore, and in a similar manner as discussed with respect to FIG. 8, any rough or unsmooth surfaces remaining on capping portion 22 due to the removal of connecting member 17′ may be treated to form a smooth flat surface 101.

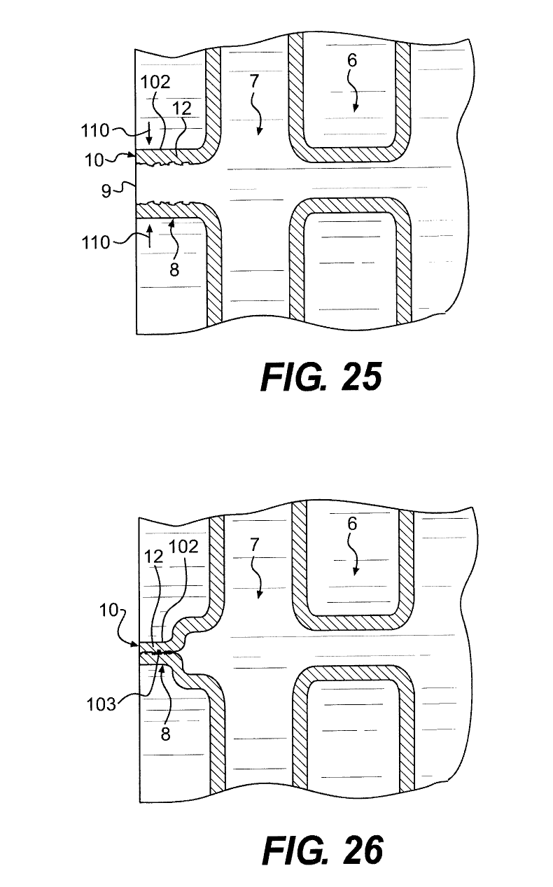

FIGS. 25-26 depict another exemplary method of sealing ventilation channel 8 of corrugated pipe 1 after portions of wall 12 have been melted by heating element 60, as discussed above with respect to FIGS. 18-19.

As shown in FIG. 25, a radial force 110 is applied to an outer surface 102 of ventilation channel 8 once ventilation channel 8 has been heated and wall 12 has been sufficiently melted. Radial force 110 may be applied by, for example, a crimping tool or by hand.

Ventilation channel 8 may be folded, such that opposite sides of melted wall 12 collapse together to close ventilation hole 9 and seal ventilation channel 8. As illustrated in FIG. 26, once ventilation channel 8 is folded, the opposite sides of wall 12 may be held in place for a sufficient amount of time until the melted portions of each wall 12 side is melded and fastened together. A fluid-tight sealing interface 103 may then be formed by the opposite sides of wall 12 that are fastened together.

As will be appreciated by one of ordinary skill in the art, the presently disclosed corrugated pipe, sealing insert, and methods may enjoy numerous advantages over previously known corrugated pipes. First, because sealing insert 14, 14′, 140, 340 is adapted to be readily utilized with common spinning mechanisms, such as a mechanical drill, ventilation channel 8 may be easily and quickly sealed immediately after corrugated pipe 1 has cooled down from the molding process. Additionally, the general compatibility between sealing insert 14, 14′, 140, 340 and common spinning mechanisms provides eased transportation to and installation at a jobsite. For example, a sealing kit including a plurality of sealing inserts having various sizes may be readily transported to the jobsite. At the jobsite, an installer may inspect ventilation channel and choose an appropriately sized sealing insert from the kit. The installer then may employ the spinning mechanism to spin weld the appropriate sealing insert into ventilation channel 8. Furthermore, connecting member 17, 17′, 170 provides a readily engageable linkage to the spinning mechanism for installation of sealing insert 14, 14′, 140 while also providing a readily detachable linkage once sealing insert 14, 14′, 140 has been appropriately sealed within ventilation channel 8, by, for example, shearing or cleaving connecting member 17, 17′, 170 from insertion body 15 or capping portion 22, 220. Connection port 420 provides a readily detachable linkage between insertion body 350 and a bit or rod of a spinning mechanism.

Moreover, spin welding sealing insert 14, 14′, 140, 340 within ventilation channel 8 provides an effective seal without the need for prolonged drying times and/or dry conditions often associated with adhesives and other welding applications. Further, since the bond between sealing insert 14, 14′, 140, 340 and ventilation channel 8 includes welding together wall 12 material and insertion body 15, 15′, 150, 350 material, ventilation channel 8 is enclosed from its outside environment by a stronger fluid-tight seal. Such a fluid-tight seal is resistant to disassembly due to deterioration and degradation from external forces and elements, such as fluids, dirt, and debris, from a jobsite.

The many features and advantages of the present disclosure are apparent from the detailed specification, and thus, it is intended by the appended claims to cover all such features and advantages of the present disclosure which fall within the true spirit and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What is claimed is:

1. A method of sealing a ventilation channel for a pipe, the method comprising:
inserting a sealing insert into a ventilation hole of the ventilation channel;
applying a vibrational energy to a region between the sealing insert and the ventilation channel;
deactivating the vibrational energy once the sealing insert and the ventilation channel are welded together at the region; and
forming a flush interface between the sealing insert and the ventilation channel at the ventilation hole.

2. The method of claim 1, wherein the vibrational energy is an ultrasonic vibration.

3. The method of claim 1, further comprising applying forward pressure to the sealing insert as the vibrational energy is applied to the region.

4. The method of claim 1, further comprising engaging the sealing insert with an outer periphery of the ventilation hole.

5. The method of claim 4, further comprising applying vibrational energy at the outer periphery of the ventilation hole.

6. The method of claim 1, wherein forming the flush interface includes removing material from at least the sealing insert.

7. The method of claim 1, wherein the pipe is a corrugated pipe, and the ventilation channel is fluidly coupled to a plurality of corrugations of the corrugated pipe.

8. A method of sealing a ventilation channel for a pipe, the method comprising:
inserting a sealing insert into a ventilation hole of the ventilation channel;
applying heat to the sealing insert such that the sealing insert melts within the ventilation channel; and
manipulating the melting sealing insert to cover the ventilation hole.

9. The method of claim 8, further comprising securing the sealing insert to a wall of the ventilation channel prior to applying heat to the sealing insert.

10. The method of claim 8, further comprising applying heat to a wall of the ventilation channel.

11. The method of claim 8, wherein applying heat to the sealing insert includes conducting an electrical current through an electrically conductive member embedded within the sealing insert.

12. The method of claim 10, further comprising directly contacting the wall of the ventilation channel and the sealing insert with a heating element.

13. The method of claim 8, further comprising manipulating the sealing insert once a portion of the sealing insert is melted to cover an outer periphery of the ventilation hole.

14. The method of claim 11, further comprising removing a first portion of the sealing insert welded within the ventilation channel from a second portion of the sealing insert.

15. The method of claim 14, further comprising separating a first portion of the electrically conductive member from a second portion of the electrically conductive material.

16. The method of claim 8, wherein the pipe is a corrugated pipe, and the ventilation channel is fluidly coupled to a plurality of corrugations of the corrugated pipe.

17. A method of sealing a ventilation channel for a pipe, the ventilation channel including a ventilation hole and a wall, the method comprising:
applying heat to opposite sides of the wall;
folding the opposite sides of the wall together to close the ventilation hole and seal the ventilation channel; and
applying pressure to the folded channel wall.

18. The method of claim 17, further comprising directly contacting the wall with a heating element.

19. The method of claim 17, further comprising forming a fluid-tight sealing interface between the opposite sides of the wall.

20. The method of claim 17, wherein the pipe is a corrugated pipe, and the ventilation channel is fluidly coupled to a plurality of corrugations of the corrugated pipe.
